(19) United States
(12) Patent Application Publication
(10) Pub. No.: US 2012/0133297 A1
(43) Pub. Date: May 31, 2012

(54) Method for Actuating a Discharge Lamp and Circuitry for Operating Such a Lamp

(76) Inventor: Thomas Pollischansky, Munchen (DE)

(21) Appl. No.: 13/389,395

(22) PCT Filed: Jul. 23, 2010
(86) PCT No.: PCT/EP2010/060716

§ 371 Date: Feb. 7, 2012

(30) Foreign Application Priority Data
Aug. 7, 2009 (DE) 10 2009 036 645.8

(51) Int. Cl. H05B 41/36

(52) U.S. Cl. 315/224

(57) ABSTRACT

A method for actuating a discharge lamp (LP), wherein in order to ignite the lamp a resonant circuit (L, C₁) is brought into resonance or near resonance by the action of alternating current and as a result adjustment to give a predetermined amperage is performed by varying the frequency of the alternating current. For this purpose a measuring device transmits measured values of the amperage to means for controlling the frequency, and these means establish the frequency in dependence on the measured values. Before the ignition voltage is applied the electrodes of the lamp are pre-heated by the action on the resonant circuit of alternating current of a different frequency than when the lamp is ignited. During pre-heating a predetermined amperage is set by adjustment in that the means for controlling the frequency are already activated and the procedure is such that the measuring device obtains measured values of the amperage and transmits them to the means for controlling, these measurement values corresponding to an amperage which deviates in a predetermined manner from the amperage specified by measured values during ignition.

### BACKGROUND OF THE INVENTION

The invention relates to a method for actuating a discharge lamp, according to the preamble of claim 1. It also relates to a circuit arrangement for operating a discharge lamp, according to the preamble of claim 3.

### PRIOR ART

The invention takes as its starting point a circuit arrangement for operating a discharge lamp according to the preamble of claim 3 as used in-house by the applicant, which implements the method according to the preamble of claim 1:

The circuit arrangement has a resonant circuit, having a capacitive element which is connected in parallel with the discharge lamp and an inductive element which is in series upstream of the lamp and the capacitive element and downstream of a switching point between two switches. The switches, which typically take the form of MOSFETs, serve to apply current to the resonant circuit. Suitable means cause the two switches to be closed and opened again in a mutually alternating sequence, at predetermined switching frequency. Typically, the means for causing this include an application-specific integrated circuit (ASIC), which connects potential outputs with the control inputs of MOSFETs.

The purpose of the resonant circuit is to ensure that an ignition voltage is provided through the electrodes of the lamp, in other words in parallel with the capacitive element of the resonant circuit. To this end, a square voltage is applied over a half-bridge circuit to bring about oscillation or near resonance. So that the ignition voltage is set in defined manner, adjustment to give a predetermined amperage of the alternating current is performed by varying the frequency of the square voltage. To this end, means are provided in the circuit arrangement for measuring the amperage of a current flowing through one of the switches, and suitable means for establishing the switching frequency establish the latter during ignition as a function of the measured amperage.

Before the discharge lamp is ignited, the electrodes, which are typically in the form of coils, have to be pre-heated. Pre-heating is performed by providing heat from an ohmic loss by sending a current through the electrodes. This is also carried out in the circuit arrangement by triggering the switches and hence applying alternating current to the resonant circuit. In this case, however, the frequency is different from that used when the lamp is ignited.

In circuit arrangements that have been used in-house by the applicant hitherto, the frequency of the alternating current during pre-heating was established in advance by setting it to values above the resonant frequency of the resonant circuit.

The electrical parameters of electronic components may vary from one individual component to the next even if a nominal value is desirable per se. If the frequency during pre-heating is established in advance, as was the case hitherto, the pre-heating current that is set is highly sensitive to the parameters of the electronic components, in particular the capacitive element and the inductive element of the resonant circuit. It is then possible for a circuit arrangement to be rejected during production as not functioning adequately, even if all the components are individually functional per se and only deviations in the parameters are present in the components.

Adjustment of the pre-heating current is known in a number of circuit arrangements.

### SUMMARY OF THE INVENTION

An object of the present invention is to provide a method according to the preamble of claim 1 which allows a discharge lamp to be actuated reliably even if there are deviations in the electrical parameters of the electronic components used therein. It is further an object of the present invention to provide a circuit arrangement for operating a discharge lamp according to the preamble of claim 3 which, for igniting the lamp, functions as reliably as the circuit arrangement from the applicant in its previous construction but which at the same time makes reliable pre-heating possible.

This object is achieved in the case of a method having the features of the preamble of claim 1 by the features of the characterising clause of claim 1, and in the case of a circuit arrangement having the features of the preamble of claim 3 by the features of the characterising clause of claim 3.

Particularly advantageous embodiments are to be found in the dependent claims.

According to the invention, during pre-heating a predetermined amperage is also set by adjustment, in principle in the same way as during ignition, in that the means for controlling the frequency are already activated before the ignition procedure. Since adjustment is now to be to a different amperage, however, the procedure is such that the measuring device obtains measured values of the amperage and transmits them to the means for controlling the frequency, these measurement values corresponding to an amperage which deviates in a predetermined manner from the amperage measured during ignition. Thus, in a first situation the adjustment is performed on the basis of values measured for a first amperage and in a second situation the adjustment is performed using values measured for a second amperage, in each case for the same actual amperage. Preferably, following on from the methods of the prior art, the first situation is that of ignition, during which the actual amperage is mapped by the measured values in a predetermined manner. During pre-heating, the adjustment can then be performed on the basis of measured values which deviate in a predetermined manner from the actual amperage. Typically, the peak current value is measured. When this reaches a predetermined limit value the switching frequency of the half bridge is increased.

Thus, in particular during pre-heating, measurement of the amperage is deliberately falsified. In the simplest case, an offset is simply applied. In that case the regulating circuit causes an amperage to be actually set which is offset by this amount from what which would apply otherwise or during ignition.

An offset of this kind is approximately created in that a potential which is applied across a switching point during pre-heating is not applied during ignition.

In this way, it is possible to use the already known circuit arrangement which has the regulating circuit that is used when the lamp is ignited, and the same regulating circuit can then also be used to adjust the pre-heating current. This creates a synergy effect: a separate regulating circuit need not be provided for adjustment of the pre-heating current. A commercially available control ASIC which has no properties for adjusting the pre-heating current can regulate the pre-heating current using the circuit according to the invention.

In the case of the circuit arrangement according to the preamble of claim 3, according to the invention control means are provided for influencing the measured values obtained by the means for measuring, such that when an actuating program is executed the measured values can be influenced in this way at a suitable point in time, in particular during pre-heating.

Preferably, the control means include a source for providing a fixed potential (typically defined in relation to ground) across a switching point of the circuit arrangement. This may be, for example, an output for triggering pre-heating by transformer, by means of MOSFET switch. Alternatively, another output signal, which has a different potential during pre-heating from that in the other operating states, may, be used. This is for example the RTPH output in the Infineon control ASIC ICV1FL02G. By manipulating decreased voltages across resistors and hence currents that flow through these, the measured amperage is also manipulated, with an amperage that otherwise remains constant flowing through one of the switches.

Thus, a particular amperage may flow through one of the switches, and when the fixed potential is not present a first value for the amperage may be measured, and when the fixed current potential is present a second value for the amperage may be measured. This is precisely the objective of being able to use the electronics that set a predetermined amperage. In that case, by manipulating the measured values for the amperage the same regulating circuit may be used both during pre-heating and during ignition.

In a simple arrangement, the means for measuring the amperage include a voltage divider having two resistor elements. It is then sufficient for a switching point between the two resistor elements to be connected by way of a further resistor element to the source in order for the ratio between the decreased voltages across the two resistor elements to be changed. The further resistor element preferably has a resistance which is at least five times and preferably at least ten times as large as the largest resistance of the two resistor elements. The reason for this is to avoid generating excessively large additional currents but only to change the potential. The greater the resistance of the further resistor element, the greater the effect of a simple offset when measuring the amperage.

In the preferred embodiment, the circuit arrangement includes, as known per se from the prior art, an application-specific integrated circuit which includes two potential outputs for triggering the switches and a potential input which is part of the means for measuring and is connected for example to the switching point between the two resistor elements. It is within the scope of the invention to provide and use a third potential output which serves to provide the source.

Since some application-specific integrated circuits do not necessarily provide the ideal voltage source, in a preferred embodiment the third potential output is connected to ground by way of a Zener diode, in which case a capacitive element is preferably additionally connected in parallel therewith. In this case current flows from the potential output through the Zener diode, and the decreased voltage across this can be regarded as stable, such that a stable voltage source is provided, so this provides particularly good definition of the potential at the switching point of the circuit arrangement.

### BRIEF DESCRIPTION OF THE DRAWING(S)

The invention will be described in more detail below with reference to two exemplary embodiments. In the drawings:

FIG. 1 shows the circuit diagram of a circuit arrangement for a discharge lamp according to the prior art,

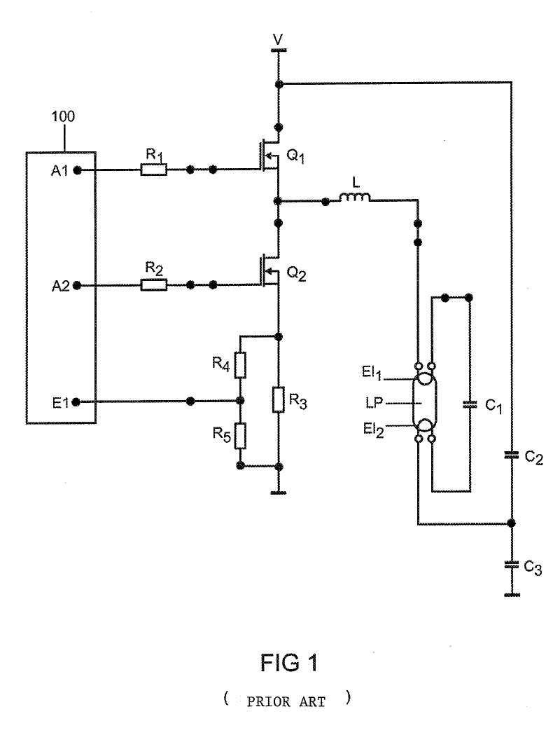

FIG. 2 shows a circuit diagram for a discharge lamp as implemented according to a first embodiment of the invention,

FIG. 3 shows a circuit diagram for a discharge lamp as implemented according to a second embodiment of the invention, and

FIG. 4 shows two graphs for illustrating the advantages of the invention over the prior art.

### PREFERRED EMBODIMENT OF THE INVENTION

A capacitive element C₁ is connected in parallel with a discharge lamp LP, for example a low-pressure discharge lamp. The two electrodes El₁ and El₂ of the lamp LP are connected to either side of a capacitor C₁. Connected in series with the lamp LP and hence also the capacitive element C₁ is an inductive element L. The electrode El₂ is connected to a potential V by way of a capacitive element C₂ and to ground by way of a capacitive element C₃. Two switches Q₁ and Q₂ which take the form of MOSFETs may connect the series circuit comprising the inductive element and the discharge lamp (or the capacitive element C₁) to the potential V (switch Q₁) or to ground (switch Q₂). The control inputs of the switches are connected to potential outputs A1, A2 of an application-specific integrated circuit 100 by way of resistor elements R₁ and R₂ respectively. Means provided in the circuit trigger the switches Q₁ and Q₂ in precisely alternating manner such that the capacitor C₁ is alternately charged from the potential V by way of the switch Q₁ and discharged to ground by way of the switch Q₂. Because the elements L and C₁ form a resonant circuit, the amperage of the current flowing through the electrodes El₁ and El₂ of the lamp LP can be adjusted with a high level of sensitivity. This is done by varying the frequency using suitable means in the integrated circuit 100.

The resonant circuit having the elements L and C₁ is used in particular when the discharge lamp LP is ignited. The resonant circuit is brought into resonance, or near resonance, such that extremely high voltages are applied between the electrodes El₁ and El₂, in order that the discharge lamp is ignited.

In this phase of ignition, it is important that predetermined and decreased voltages apply. For this purpose, the amperage is adjusted. The switch Q₂ connects the inductive element L to ground by way of a resistor element R₃. Provided in parallel with the resistor element R₃ is a voltage divider having the resistor elements R₄ and R₅, and the switching point between these two resistor elements R₄ and R₅ is connected to a potential input E1 of the application-specific integrated circuit. The potential input allows the decreased voltage across the resistor element R₅, and hence the amperage of the current flowing through the switch Q₂, to be measured. The frequency of opening and closing the switches Q₁ and Q₂ is determined in the application-specific integrated circuit 100 as a function of the voltage measured in this way. The value of the potential measured at the potential input, or the decreased voltage occurring in relation to ground, thus determines the output potentials at the potential outputs A1 and A2 and the frequency thereof.

Before ignition, the electrodes El₁ and El₂ have to be pre-heated. In the prior art, the adjustment which is used during ignition of the discharge lamp LP has not hitherto been used for this. Instead, a particular frequency for the amperage is provided in the application-specific integrated circuit 100, and this frequency acts on the outputs A1 and A2 during pre-heating. A particular alternating current is then established and is used as the pre-heating current.

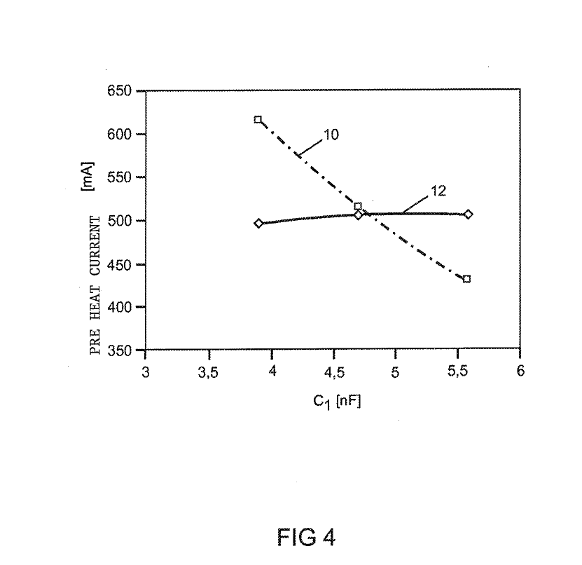

The disadvantage here is that variation and fluctuations in the parameters of the capacitive element C₁ and the inductive element L are not taken into account. If for example the actual capacitance C₁ differs markedly from the setpoint value, the pre-heating current is falsified to a marked degree: FIG. 4 shows, by way of the curve 10, that for example if the capacitive element C₁ varies between 4 and 5.5 nF, the pre-heating current may vary between more than 600 and 425 mA. This variation is too great for practical applications.

In the invention, a further potential output A3 is provided which is connected by way of a resistor element R₆ to the switching point between the resistor elements R₄ and R₅ and hence ultimately to the potential input E1. If the resistor element R₃ has a resistance of 1 Ω and the resistor elements R₄ and R₅ each have a resistance of 1 kΩ, then R₆ should for example be selected to have a resistance of 10 kΩ. If a potential of 12 V in relation to ground is now applied across the potential output A3, when typically a decreased voltage of 2 V applies across the resistor elements R₄ and R₅, then an offset is produced in the potential at the switching point between the resistor elements R₄ and R₅. The threshold of adjustment for the current is reduced by this offset. The application-specific integrated circuit 100′ is the same as the application-specific integrated circuit 100 with the additional use of the potential output A3. If, during pre-heating, a potential of 12 V is applied across the potential output A3, but in the interior of the application-specific integrated circuit 100′ the potentials detected at the potential input El continue to be measured and the adjustment is made in dependence on these measured values, then on the basis of the offset in the measured values adjustment is made to give a different amperage than would be the case if the potential were not applied across the potential output A3.

Thus, by suitable selection of the potential at the potential output A3 and the resistor element R₆ to suit the resistor elements R₄ and R₅, the pre-heating current may adopt a defined ratio to the ignition current. During pre-heating, the potential is applied across the potential output A3 and then adjustment is performed to give a particular pre-heating current. During ignition, potential is no longer applied, so that the switching point between the resistor elements R₄ and R₅ remains unaffected. Then adjustment is made to give the ignition current in a manner known per se.

It can be seen from the curve 12 in FIG. 4 that, as a result of adjusting the pre-heating current, even when there are relatively large fluctuations in the value of the capacitance of the capacitive element C₁, almost the same pre-heating current flows constantly. This is precisely the desired effect. The components of the regulating circuit typically have a lower tolerance than the components L and C₁.

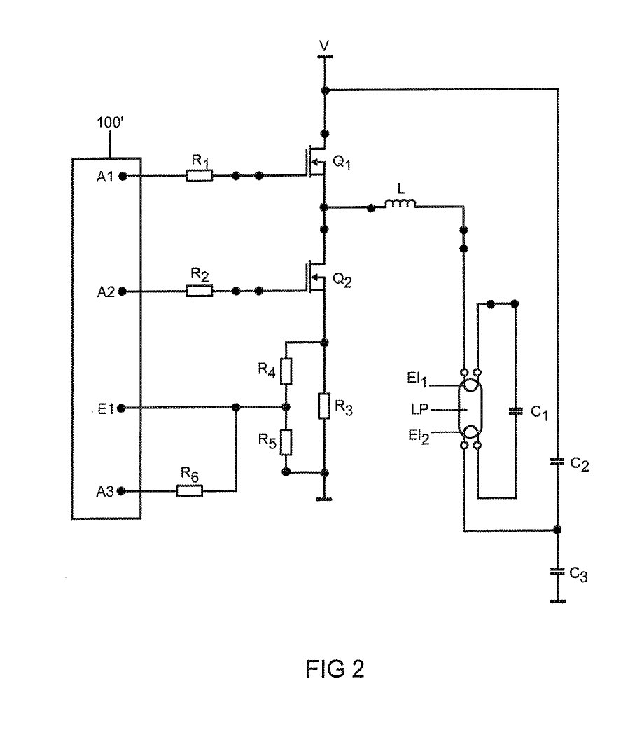

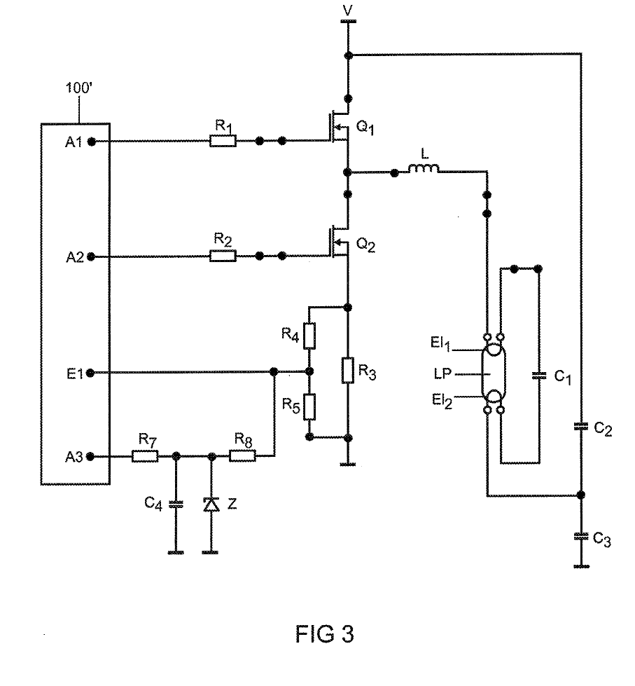

Unlike the embodiment according to FIG. 2, according to FIG. 3 it may be provided for an application-specific integrated circuit 100′ which is not necessarily suitable as a voltage source to be used. In that case, the potential output A3 may be connected to ground, by way of a resistor element R₇ and a parallel arrangement comprising a Zener diode and a capacitive element C₄, and at the same time to the switching point between the resistor elements R₄ and R₅ by way of the resistor element R₈. When a potential is applied across the potential output A3, a current flows through the Zener diode Z and the decreased voltage across this is sufficiently stable for a kind of voltage source to be provided, and thus a fixed potential.

In the embodiments according to FIG. 2 and FIG. 3, the invention uses the intelligence of an application-specific integrated circuit as known from the prior art. In the prior art, this intelligence serves to adjust to give a particular amperage when the lamp LP is ignited. By extending the application-specific integrated circuit 100 to give the application-specific integrated circuit 100′ and by means of the circuitry according to FIG. 2 or FIG. 3, this same intelligence may also be used to adjust to give a particular amperage during pre-heating.

1. A method for actuating a discharge lamp, wherein in order to ignite the lamp a resonant circuit is brought into resonance or near resonance by the action of alternating current and as a result adjustment to give a predetermined amperage is performed by varying the frequency of the alternating current, wherein for this purpose a measuring device transmits measured values of the amperage to means for controlling the frequency, and these means establish the frequency in dependence on the measured values, and wherein before the ignition voltage is applied the electrodes of the lamp are pre-heated by the action on the resonant circuit of alternating current of a different frequency than when the lamp is ignited, wherein during pre-heating a predetermined amperage is set by adjustment in that the means for controlling the frequency are already activated and the procedure is such that the measuring device obtains measured values of the amperage and transmits them to the means for controlling, these measurement values corresponding to an amperage which deviates in a predetermined manner from the amperage specified by measured values during ignition.

2. The method according to claim 1, wherein during pre-heating a potential is applied across a switching point which is not applied during ignition, or a potential is not applied which is applied during ignition.

3. A circuit arrangement for operating a discharge lamp having a capacitive element which is connected in parallel with the discharge lamp and an inductive element which is in series upstream of the discharge lamp and the capacitive element, such that a resonant circuit is formed, and having two switches for applying current to the resonant circuit, having means for closing the two switches in a mutually alternating sequence at a switching frequency, having means for measuring the amperage of a current flowing through one of the switches, and having means for establishing the switching frequency as a function of the measured amperage, and further comprising control means for influencing the measured values obtained by the means for measuring.

4. The circuit arrangement according to claim 3, wherein the control means include a source for providing a fixed potential across a switching point of the circuit arrangement.

5. The circuit arrangement according to claim 4, wherein the means for measuring include a voltage divider having two resistor elements, and wherein a switching point between the two resistor elements is connected by way of a further resistor element to the source.

6. The circuit arrangement according to claim 5, wherein the further resistor element has a resistance which is at least five times as large as the largest resistance of the two resistor elements.

7. The circuit arrangement according to claim 4, having an application-specific integrated circuit which includes two potential outputs for triggering the switches, a potential input of the means for measuring and a third potential output for providing the source.

8. The circuit arrangement according to claim 7, wherein the third potential output is connected to ground by way of a resistor, a Zener diode and preferably in addition a capacitive element connected in parallel with the Zener diode.
